(19) United States
(12) Patent Application Publication
(10) Pub. No.: US 2009/0016503 A1
(43) Pub. Date: Jan. 15, 2009

(54) APPARATUS AND METHOD FOR ARS AUTOMATIC PROCESSING

(75) Inventors: Sang-Bong LEE, Suwon-si (KR); Kyong-Joon CHUN, Seoul (KR); Nak-Koo KIM, Seongnam-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/171,400

(22) Filed: Jul. 11, 2008

(30) Foreign Application Priority Data
Jul. 11, 2007 (KR) 10-2007-0069640

(51) Int. Cl. H04M 11/00

(52) U.S. Cl. 379/93.27

(57) ABSTRACT

In an Automatic Response System (ARS) automatic processing apparatus and method, a keypad enters an event for an ARS access, and a memory stores information on sequentially transmitted sequences. A Dial Tone Multi-Frequency (DTMF) generator outputs a DTMF signal corresponding to each of the sequences, and a controller controls the DTMF generator so as to output the DTMF signal corresponding to the sequence at predetermined times, upon detecting the event entry.

### CROSS REFERENCE TO RELATED APPLICATION

This application claims priority from and the benefit of Korean Patent Application No. 10-2007-0069640, filed on Jul. 11, 2007, which is hereby incorporated by reference for all purposes as if fully set forth herein.

### BACKGROUND OF THE INVENTION

1. Field of the Invention

The present invention relates generally to an apparatus and method for Automatic Response System (ARS) automatic processing, and in particular, to an ARS automatic processing apparatus and method capable of enabling automatic use of an ARS service without separate user's key entry in a wire/wireless telephone.

2. Discussion of the Background

An Automatic Response System (ARS) refers to a computer system that has possibly expected responses recorded in its storage, analyzes a received external telephone inquiry, selects a corresponding response, and transmits the selected response in voice, thereby automatically responding to the inquiry. At present, the ARS service is widely used by banks, credit card companies, public agencies, service centers, etc. In particular, as personal financial transactions are becoming more common, many people frequently use the ARS service of financial institutions such as banks and credit card companies.

Telebanking service is the typical ARS service of banks. With telebanking, which is a service that permits customers to carry on their financial transactions by telephones without visiting a bank, customers can immediately transfer their funds to other accounts and can typically access the system 24-hours a day.

FIG. 1 is a flowchart illustrating a conventional process for Telebanking service processing. As shown in FIG. 1, in order to use the Telebanking service, a user should first enter an ARS phone number of the corresponding bank into the telephone (Step S1). After the call is made, access to an ARS of the bank is made (Step S2), and the user listens to the ARS voice comment. Thereafter, the user enters any necessary numbers (service number, account number, password, identification (ID) number, etc.) according to the ARS voice comment by pressing keys on the phone (Step S3). When the final entry is completed, the corresponding financial service (account transfer, transaction inquiry, balance inquiry, etc.) may be processed (Step S4). If the user wants another financial service, they may return to the previous menu and enter the necessary numbers according to the ARS voice comment, or otherwise, the user may end the ARS access (Step S5).

Here, in order to receive the corresponding financial service, a user desiring to use the Telebanking service must enter the necessary numbers one by one according to the voice comment, causing inconvenience. In addition, for the user who repeatedly uses the same financial service, the repeated number entry can be annoying.

### SUMMARY OF THE INVENTION

The present invention provides an ARS automatic processing apparatus and method by which a user can automatically receive a desired service without entering numbers one by one after accessing the ARS.

Additional features of the invention will be set forth in the description which follows, and in part will be apparent from the description, or may be learned by practice of the invention.

The present invention discloses an ARS automatic processing apparatus. The ARS automatic processing apparatus includes a keypad for entering an event for an ARS access, a memory for storing information on sequentially transmitted sequences, and a Dial Tone Multi-Frequency (DTMF) generator for outputting a DTMF signal corresponding to each of the sequentially transmitted sequences. A controller controls the DTMF generator so as to output the DTMF signal corresponding to each of the sequentially transmitted sequences upon detecting the event entry.

The present invention also discloses an ARS automatic processing method. The ARS automatic processing method includes providing information on a sequence to be transmitted to an ARS, receiving an event entry for an ARS access, generating a DTMF signal corresponding to the sequence upon detecting the event entry for an ARS access, and transmitting the generated DTMF signal to the ARS.

The present invention also discloses another ARS automatic processing method. This method includes storing ARS access information in a memory, receiving an instruction for an ARS access that includes the ARS access information and a desired service number corresponding to a desired service, generating and transmitting a DTMF signal to the ARS to automatically establish communication with the ARS in response to the instruction for the ARS access and to automatically send the ARS access information and the desired service number to the ARS after communication is established, and receiving a processing result from the ARS after the desired service is completed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart showing a conventional process for Telebanking service processing.

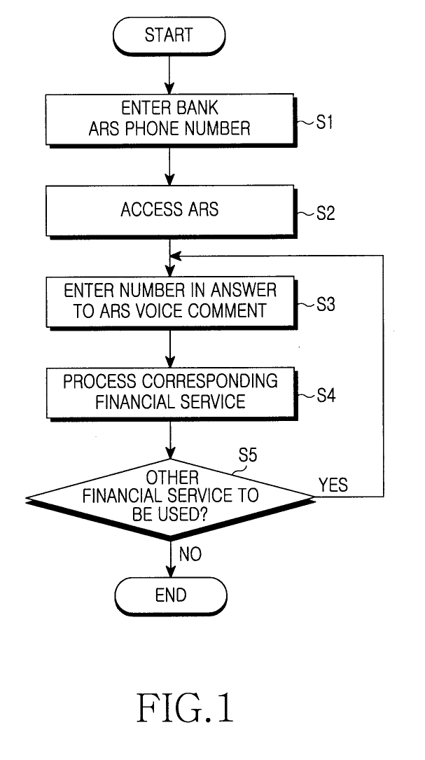

FIG. 2 is a diagram showing a schematic architecture of an ARS service system.

FIG. 3 is a block diagram showing an internal structure of an ARS automatic processing apparatus in a mobile terminal according to an exemplary embodiment of the present invention.

FIG. 4 is a flowchart showing an ARS automatic processing process according to an exemplary embodiment of the present invention.

FIG. 5 is a diagram showing a user interface for generating an ARS access event in an ARS Telebanking service according to an exemplary embodiment of the present invention.

FIG. 6 is a flowchart showing a process for ARS automatic processing according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

It will be understood that when an element is referred to as being “connected to” another element, it can be directly connected to the other element, or intervening elements may be present. In contrast, when an element is referred to as being “directly connected to” another element, there are no intervening elements present.

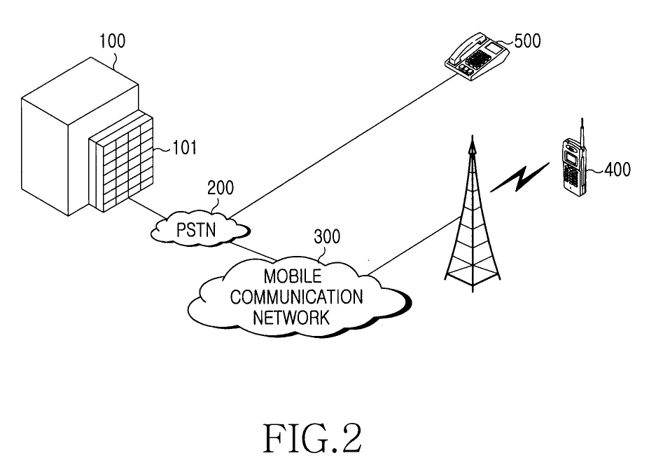

FIG. 2 shows a schematic architecture of an Automatic Response System (ARS) service system.

As FIG. 2 shows, an ARS service system includes an ARS center 100 of a financial institution, an ARS 101 installed in the ARS center 100, a mobile terminal 400 and a wire telephone 500 of a user, a Public Switched Telephone Network (PSTN) 200 for the wire telephone 500, and a mobile communication network 300 for the mobile terminal 400.

In this ARS service system, during use of the Telebanking service, if the user attempts an outgoing call to the ARS center 100 using the mobile terminal 400 or the wire telephone 500, the user may access the ARS 101 over the mobile communication network 300 or the PSTN 200. When access is made between the mobile terminal 400 or the wire telephone 500 and the ARS 101, a voice comment is output from the ARS 101 and then transmitted to the mobile terminal 400 or the wire telephone 500.

Conventionally, in an ARS that is not responsive to voice commands, the user must press numbers on a keypad in order to enter necessary data such as ID number, account number, service number (e.g., a number that corresponds to a service, such as transferring of funds or checking an account balance), and password after listening to the voice comment output from a speaker of the mobile terminal 400 or the wire telephone 500. However, in exemplary embodiments of the present invention, the mobile terminal 400 or the wire telephone 500 can automatically transmit the required data to the ARS 101.

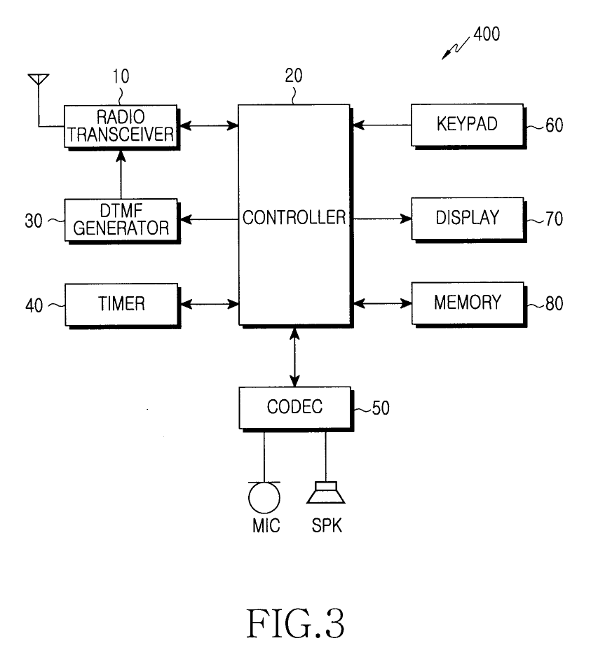

FIG. 3 shows an internal structure of an ARS automatic processing apparatus in a mobile terminal 400 according to an exemplary embodiment of the present invention.

As FIG. 3 shows, the mobile terminal 400 includes a radio transceiver 10 for modulating a voice signal before transmission and demodulating a received modulated voice signal; a controller 20 for controlling the entire communication and application operation of the mobile terminal 400; a Dial Tone Multi-Frequency (DTMF) generator 30 for generating a DTMF signal; a timer 40 for counting an operation time; a codec 50 for encoding a transmission voice signal and decoding a received encoded voice signal; a keypad 60 for performing various key entries; a display 70 for displaying an operating status of the mobile terminal 400; and a memory 80 for storing various application programs and data. The display 70 and keypad 60 may be a single unit, such as a touch screen display.

A detailed description of known functions and configurations will be omitted for clarity and conciseness, so that the description may focus on operations of the constituent blocks applied to the ARS automatic processing function according to exemplary embodiments of the present invention.

The DTMF generator 30 generates a DTMF signal using the information required by a voice comment from the ARS 101, and outputs the DTMF signal to the radio transceiver 10. The memory 80 stores ARS numbers of individual banks, the information required by the voice comment, such as service number, account number, ID number, password, etc, the order in which the information will be required, and the timing between each piece of required information.

The timer 40 counts the time elapsing from a reference time, and determines the time when the DTMF signal generated by the DTMF generator 30 is output. Although it is shown in FIG. 3 that the timer 40 is installed outside the controller 20, it can also be formed integral with the controller 20.

Upon detecting an ARS access event from the keypad 60, the controller 20 makes an ARS access with an ARS number stored in the memory 80, and starts the timer 40 to send the information stored in the memory 80 to the DTMF generator 30 at every predetermined time. Then the DTMF generator 30 generates a DTMF signal corresponding to the information received from the controller 20.

The keypad 60 is a device for presetting the information necessary for the ARS service and entering an ARS access event. In an exemplary embodiment of the present invention, after an ARS access event is entered, the keypad 60 is deactivated until the DTMF generator 30 completes the output of the DTMF signal, so that no other data is input during the service. After the output of the DTMF signal is completed, the keypad 60, which was deactivated for the next service, is reactivated.

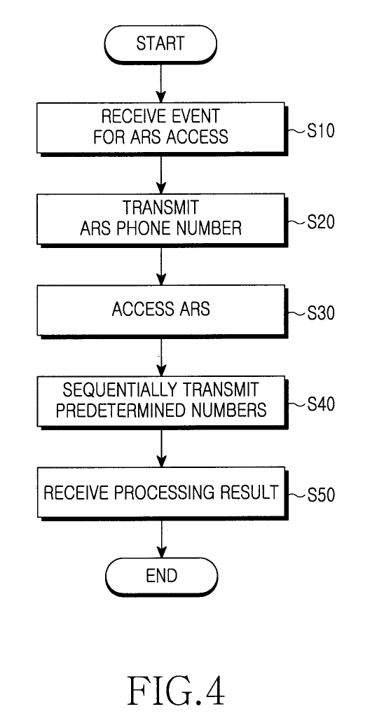

FIG. 4 shows an ARS automatic processing process according to an exemplary embodiment of the present invention.

As shown in FIG. 4, when an event for an ARS access is received by a mobile terminal 400 or a wire telephone 500 (Step S10), an ARS phone number corresponding to the event is transmitted (Step S20). If the mobile terminal 400 or wire telephone 500 is connected to a corresponding ARS 101 (Step S30) once the ARS phone number is transmitted, the numbers previously stored in the memory 80 and that correspond to the ARS 101 are sequentially transmitted at every predetermined time (Step S40). After the last number is transmitted, the mobile terminal 400 or wire telephone 500 can finally receive the processing result on the corresponding service from the ARS 101 (Step S50).

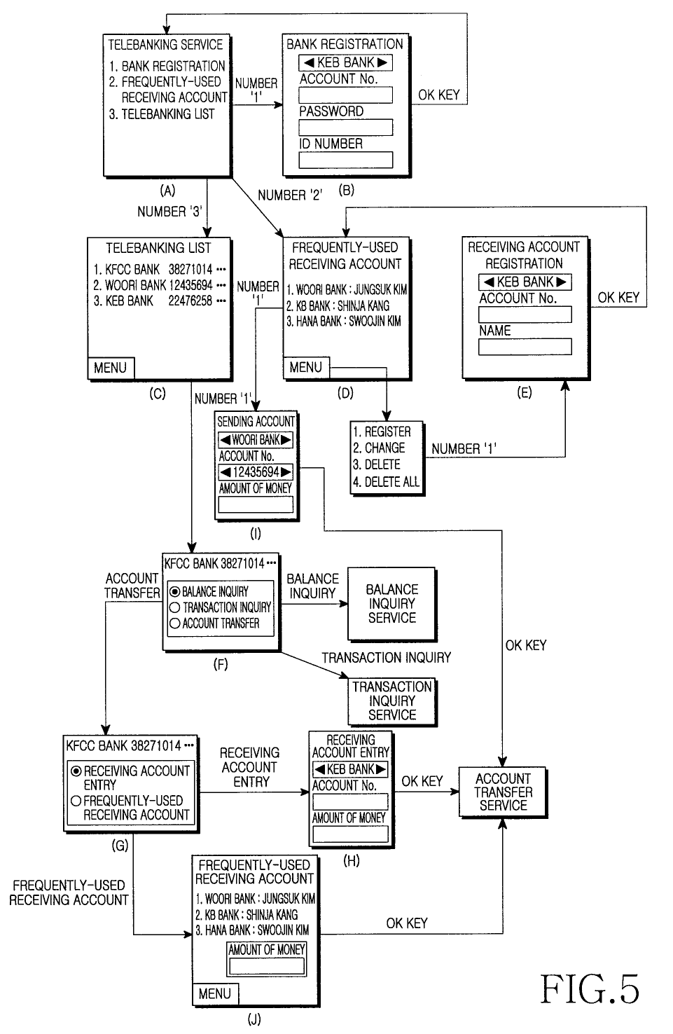

FIG. 5 shows a user interface for generating an ARS access event in an ARS Telebanking service according to an exemplary embodiment of the present invention.

As shown in FIG. 5, when a user enters an ARS Telebanking service menu using a mobile terminal 400, a screen A is displayed on a display 70 of the mobile terminal 400. For example, the items ‘Bank Registration’, ‘Frequently-Used Receiving Account’, and ‘Telebanking List’ are displayed on the Telebanking Service Menu screen A.

If the user presses a number ‘1’ of a keypad 60 or presses OK key after putting the cursor on the item ‘Bank Registration’ in the Telebanking Service Menu screen A, a screen B is displayed. The user then sequentially enters a bank name, a bank account number, a password, and an ID number in the Bank Registration screen B, thereby performing a Bank Registration procedure. If the user presses OK key after completing the Bank Registration procedure, the user interface returns to the Telebanking Service Menu screen A.

If the user presses a number ‘2’ of the keypad 60 or presses OK key after putting the cursor on the item ‘Frequently-Used Receiving Account’ in the Telebanking Service Menu screen A, a screen D is displayed. The frequently-used receiving accounts including the bank names and depositor's names are displayed on the Frequently-Used Receiving Account screen D. If the user presses a Menu tap displayed on the bottom left of the screen D, its sub-items are displayed in a ‘Pop-Up’ fashion. In this state, if the user presses a number ‘1’ or presses OK key after putting the cursor on an item ‘Register’, a screen E is displayed. The user enters a bank name, a bank account number, and depositor's name in the Receiving Account Registration screen E, thereby performing a Receiving Account Registration procedure. If the user presses OK key after the Receiving Account Registration procedure is completed, the newly registered receiving account is added when the user interface returns to the Frequently-Used Receiving Account screen D. If the user selects any bank name (for example, presses a number ‘1’) in the screen D, a Sending Account screen I is displayed. The most recently-used sending account may be displayed on the Sending Account screen I for user convenience of account entry, or otherwise, the user can enter a bank name and account number of the desired sending account. After the sending account is determined, if the user presses OK key after entering the amount of money that he/she desires to send, in an amount-of-money field, after accessing the ARS 101, the entered amount of money may be withdrawn from the determined sending account and then sent to the receiving account selected in the screen D, performing an Account Transfer service.

If the user presses a number ‘3’ of the keypad 60 or presses OK key after putting the cursor on the item ‘Telebanking List’ in the Telebanking Service Menu screen A, a screen C is displayed. The bank names registered in the Bank Registration procedure are displayed on the Telebanking List screen C. If the user selects any bank name (for example, presses a number ‘1’) in screen C, a Telebanking Service Selection screen F is displayed. For example, the items ‘Balance Inquiry’, ‘Transaction Inquiry’ and ‘Account Transfer’ are displayed on the Telebanking Service Selection screen F. In this state, if the user presses OK key after selecting the item ‘Balance Inquiry’ or ‘Transaction Inquiry’, the user can receive the Balance Inquiry or Transaction Inquiry service for the bank selected in the Telebanking List screen C. If the user presses OK key after selecting the item ‘Account Transfer’, a screen G is displayed. For example, the items ‘Receiving Account Entry’ and ‘Frequently-Used Receiving Account’ are displayed on the screen G. If the user selects the item ‘Receiving Account Entry’, a screen H is displayed. If the user presses OK key after entering a bank name, an account number, and an amount of money for the desired receiving account in the Receiving Account Entry screen H, after accessing the ARS 101, the amount of money entered in the Receiving Account Entry screen H is withdrawn from the bank account selected in the Telebanking List screen C, and then undergoes the Account Transfer service to the bank account entered in the Receiving Account Entry screen H. However, if the user selects the item ‘Frequently-Used Receiving Account’, the screen D is first displayed, and in this state, if the user selects any bank name, a window for entering an amount of money is popped up as shown in a screen J. If the user presses OK key after entering the desired amount of money in the amount-of-money window, after accessing the ARS 101, the amount of money entered in the Frequently-Used Receiving Account screen J is withdrawn from the bank account selected in the Telebanking List screen C, and then undergoes the Account Transfer service to the bank account selected in the Frequently-Used Receiving Account screen D.

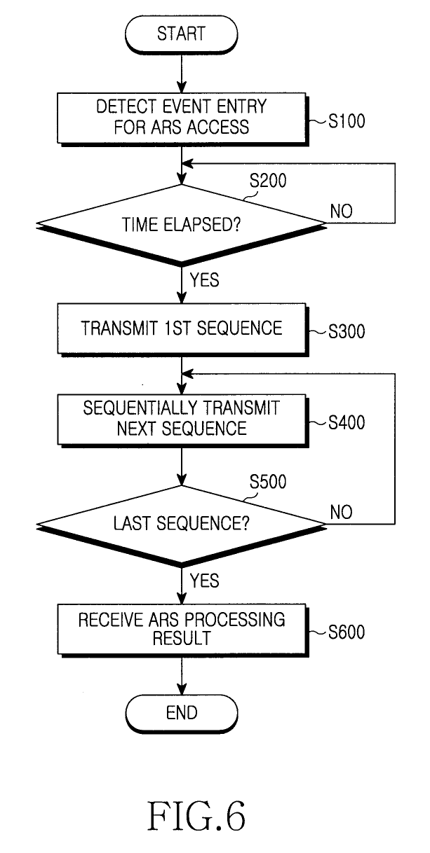

FIG. 6 is a flowchart showing a process for ARS automatic processing according to an exemplary embodiment of the present invention.

After entering a Telebanking Service menu A, a mobile terminal 400 sequentially performs the procedures for receiving the desired Telebanking service, as described with reference to FIG. 5. Upon detecting a key entry (event entry for ARS access) in the final step of the Telebanking service procedure (Step S100), the mobile terminal 400 determines whether a predetermined time has elapsed from the event entry detected time (Step S200). Since a specific time is required until the mobile terminal 400 accesses an ARS 101 after detecting the event entry for ARS access, the mobile terminal 400 previously sets the specific time taking into account the access time required individually for an ARS of each bank. After the specific time lapses, the mobile terminal 400 transmits a first sequence to the ARS 101 (Step S300). Thereafter, the mobile terminal 400 sequentially transmits the predetermined next sequence following the first sequence (Step S400). The mobile terminal 400 determines whether the currently transmitted sequence is the last sequence (Step S500). If the currently transmitted sequence is not the last sequence, the mobile terminal 400 transmits the remaining preset sequences. On the other hand, if the currently transmitted sequence is the last sequence, the mobile terminal 400 completes the sequence transmission and receives the ARS processing result from the ARS 101 (Step S600). The term ‘sequence’ as used herein refers to a combination of service number, ID number, password, and the like necessary for the Telebanking service, and in particular, refers to a DTMF signal associated with these numbers in an exemplary embodiment of the present invention. Regarding the sequences, a first sequence through an N^{th} sequence can be set in association with the types of services.

A detailed description will now be made of the process of FIG. 6 for an ARS service of a particular bank, by way of example. At the time where the user presses the final key in the user interface of FIG. 5 to implement a Balance Inquiry Service of, for example, Korea Exchange Bank (KEB), an access is made to KEB's ARS number ‘1588-3500’, which has been previously stored. When the KEB ARS is accessed, a previously stored Balance Inquiry Service number (for example, a number ‘1’) is transmitted at the time where a voice comment ‘This is a KEB Call Center’ is output to the mobile terminal 400. Here, the time where the voice comment is output may correspond to the time where, for example, the first syllable of the voice comment is output. A previously stored account number is transmitted at the time where the ARS outputs a voice comment ‘Please enter your account number’ to the mobile terminal 400 in response to the received Balance Inquiry Service number. Next, a previously stored password is transmitted at the time where the ARS outputs a voice comment ‘Please enter your password’ to the mobile terminal 400 in response to the received account number. Thereafter, the ARS provides the user of the mobile terminal 400 with information on the balance of the account, for example, a voice comment ‘Your balance is 869,100 won’, in response to the received password.

Although the numbers transmitted from the mobile terminal 400 are converted into a DTMF signal before being transmitted, for security purposes, they can be encrypted before transmission. In addition, every time the numbers needed in each service are sequentially transmitted, the current service status can be displayed on a display 70 of the mobile terminal 400, so that the user can visually check the status of the current service. The service result finally processed in the ARS is output in voice, and the output voice can be recorded in the memory 80 while being output.

The data, which should be sequentially transmitted, and information on a transmission interval thereof may be previously stored in the mobile terminal 400, separately for a corresponding service of each bank. Since a corresponding service of each bank has a different data transmission time, it is necessary to prepare software by analyzing a length of an ARS voice comment of the Telebanking service for each bank so that the data required in the corresponding service can be transmitted at the right time. This software may be previously stored in the memory 80 during manufacturing of the mobile terminal 400. When the ARS service of a bank changes, it may be necessary to update the previously stored software. Therefore, every time the ARS service of a bank changes, new software can be prepared for the mobile terminal 400 and provided to the user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An Automatic Response System (ARS) automatic processing apparatus, comprising:
a keypad to enter an event for an ARS access;
a memory to store information on sequentially transmitted sequences;
a Dial Tone Multi-Frequency (DTMF) generator to output a DTMF signal corresponding to each of the sequentially transmitted sequences; and
a controller to control the DTMF generator so as to output the DTMF signal corresponding to each of the sequentially transmitted sequences upon detecting the event entry.

2. The apparatus of claim 1, wherein the keypad is deactivated after the event for the ARS access is entered and until the output of DTMF signal is completed.

3. The apparatus of claim 1, further comprising:
a display to display a status corresponding to the output of the DTMF signal.

4. The apparatus of claim 1, wherein the memory stores an ARS response result generated after the output of the DTMF signal is completed.

5. An Automatic Response System (ARS) automatic processing method, comprising:
providing information on a sequence to be transmitted to an ARS;
receiving an event entry for an ARS access;
generating a Dial Tone Multi-Frequency (DTMF) signal corresponding to the sequence upon detecting the event entry for an ARS access; and
transmitting the generated DTMF signal to the ARS.

6. The method of claim 5, wherein transmitting the generated DTMF signal comprises:
sequentially transmitting DTMF signals corresponding to sequences to the ARS at predetermined times beginning from a time when the event entry happens.

7. The method of claim 5, wherein transmitting the generated DTMF signal comprises:
sequentially transmitting DTMF signals corresponding to a first sequence through an N^{th} sequence to the ARS.

8. The method of claim 7, wherein the DTMF signal corresponding to the first sequence is transmitted immediately after the ARS access.

9. The method of claim 7, wherein after the DTMF signal corresponding to the first sequence is transmitted, a next DTMF signal corresponding to a next sequence is transmitted after a lapse of a time required when the ARS responds to the first sequence.

10. The method of claim 7, wherein the first sequence through the Nth sequence are transmitted after being converted into a DTMF signal.

11. The method of claim 7, wherein the first sequence through the N^{th} sequence are encrypted before transmission.

12. The method of claim 7, further comprising:
storing an ARS response after transmitting the DTMF signal corresponding to the N^{th} sequence.

13. The method of claim 7, further comprising:
displaying a corresponding status every time the DTMF signal is transmitted.

14. The method of claim 7, further comprising:
upon detecting an event entry for an access to an external system, sequentially transmitting predetermined data to the external system at predetermined times beginning from a time where the event entry happens.

15. An Automatic Response System (ARS) automatic processing method comprising:
storing ARS access information in a memory;
receiving an instruction for an ARS access, the instruction comprising the ARS access information and a desired service number corresponding to a desired service;
generating and transmitting a Dial Tone Multi-Frequency (DTMF) signal to the ARS to automatically establish communication with the ARS in response to the instruction for the ARS access and to automatically send the ARS access information and the desired service number to the ARS after communication is established; and
receiving a processing result from the ARS after the desired service is completed.

16. The method of claim 15, wherein storing ARS access information comprises storing a phone number for the ARS, an account number, and a password; and

17. The method of claim 16, wherein the desired service is at least one of a funds transfer and a balance inquiry.

18. The method of claim 17, wherein the generated DTMF signal is transmitted to the ARS per a pre-set timing sequence that corresponds to the ARS.
